(19) United States
(12) Patent Application Publication
(10) Pub. No.: US 2025/0358165 A1
(43) Pub. Date: Nov. 20, 2025

(54) FORWARD LINK WAVEFORMS WITH CYCLIC PREFIX SIGNALING FOR AMBIENT INTERNET OF THINGS DEVICES

(71) Applicant: QUALCOMM Incorporated, San Diego, CA (US)

(72) Inventors: Raviteja PATCHAVA, San Diego, CA (US); Piyush GUPTA, Bridgewater, NJ (US)

(21) Appl. No.: 18/666,602

(22) Filed: May 16, 2024

(51) Int. Cl. H04L 27/26; H04L 5/00

(52) U.S. Cl. CPC H04L 27/2655; H04L 27/26025; H04L 27/2605; H04L 5/0007

(57) ABSTRACT

Methods, systems, and devices for wireless communications are described. In some examples, an ambient internet of things (AIOT) device may receive synchronization signals associated with orthogonal frequency division multiplexed (OFDM) signaling. For example, the AIOT device may receive one synchronization signal indicating whether the OFDM signal includes a cyclic prefix, a cyclic prefix duration, and a starting OFDM symbol of the OFDM signal. Alternatively, the AIOT device may receive a first synchronization signal indicating the cyclic prefix duration and the starting OFDM symbol for the OFDM signal and may receive a second synchronization signal indicating whether the OFDM signal includes the cyclic prefix. The AIOT device may determine an OFDM symbol boundary based on the synchronization signals. The AIOT device may skip a cyclic prefix of the OFDM signal based on the cyclic prefix duration, the starting OFDM symbol, and the OFDM symbol boundary.

### FIELD OF TECHNOLOGY

The following relates to wireless communications, including forward link waveforms with cyclic prefix signaling for ambient internet of things (AIOT) devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an ambient wireless device for wireless communications is described. The method may include one or more memories storing processor-executable code, one or more processors coupling with the one or more memories and individually or collectively operable to cause the ambient wireless device to, receiving one or more synchronization signals indicating a cyclic prefix duration associated with orthogonal frequency division multiplex (OFDM) signaling, receiving, subsequent to the reception of the one or more synchronization signals, an OFDM signal including at least one cyclic prefix, and decoding the OFDM signal based on a discard of the at least one cyclic prefix from the OFDM signal in accordance with the cyclic prefix duration.

An ambient wireless device for wireless communications for wireless communications is described. The ambient wireless device for wireless communications may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the ambient wireless device for wireless communications to one or more memories storing processor-executable code, one or more processors coupled with the one or more memories and individually or collectively operable to cause the ambient wireless device to, receive one or more synchronization signals indicating a cyclic prefix duration associated with OFDM signaling, receive, subsequent to the reception of the one or more synchronization signals, an OFDM signal including at least one cyclic prefix, and decode the OFDM signal based on a discard of the at least one cyclic prefix from the OFDM signal in accordance with the cyclic prefix duration.

Another ambient wireless device for wireless communications for wireless communications is described. The ambient wireless device for wireless communications may include means for one or more memories storing processor-executable code, means for one or more processors coupling with the one or more memories and individually or collectively operable to cause the ambient wireless device to, means for receiving one or more synchronization signals indicating a cyclic prefix duration associated with OFDM signaling, means for receiving, subsequent to the reception of the one or more synchronization signals, an OFDM signal including at least one cyclic prefix, and means for decoding the OFDM signal based on a discard of the at least one cyclic prefix from the OFDM signal in accordance with the cyclic prefix duration.

A non-transitory computer-readable medium storing code for wireless communications is described. The code may include instructions executable by one or more processors (e.g., directly, indirectly, after pre-processing, without pre-processing) to one or more memories storing processor-executable code, one or more processors coupled with the one or more memories and individually or collectively operable to cause the ambient wireless device to, receive one or more synchronization signals indicating a cyclic prefix duration associated with OFDM signaling, receive, subsequent to the reception of the one or more synchronization signals, an OFDM signal including at least one cyclic prefix, and decode the OFDM signal based on a discard of the at least one cyclic prefix from the OFDM signal in accordance with the cyclic prefix duration.

Some examples of the method, ambient wireless devices, and non-transitory computer-readable medium described herein may further include operations, features, means, or instructions for receiving an indication of a subcarrier spacing associated with the at least one cyclic prefix, where the at least one cyclic prefix may be discarded based on the subcarrier spacing.

In some examples of the method, ambient wireless devices, and non-transitory computer-readable medium described herein, receiving one or more synchronization signals may include operations, features, means, or instructions for receiving a single synchronization signal indicating a first cyclic prefix configuration of a set of multiple cyclic prefix configurations may be applied to the OFDM signal, where the at least one cyclic prefix may be discarded based on the first cyclic prefix configuration.

In some examples of the method, ambient wireless devices, and non-transitory computer-readable medium described herein, the one or more synchronization signals indicate a presence of one or more cyclic prefixes in the OFDM signal.

In some examples of the method, ambient wireless devices, and non-transitory computer-readable medium described herein, the one or more synchronization signals indicate a symbol position of one or more cyclic prefixes in the OFDM signal.

In some examples of the method, ambient wireless devices, and non-transitory computer-readable medium described herein, the one or more synchronization signals indicate a symbol boundary associated with one or more symbols of the OFDM signal.

In some examples of the method, ambient wireless devices, and non-transitory computer-readable medium described herein, receiving the one or more synchronization signals may include operations, features, means, or instructions for receiving a first synchronization signal for synchronizing with a symbol boundary and receive a second synchronization signal indicating a first cyclic prefix configuration of a set of multiple cyclic prefix configurations may be applied to the OFDM signal, where the at least one cyclic prefix may be discarded based on the first cyclic prefix configuration.

In some examples of the method, ambient wireless devices, and non-transitory computer-readable medium described herein, the second synchronization signal may be received after reception of the first synchronization signal.

In some examples of the method, ambient wireless devices, and non-transitory computer-readable medium described herein, the second synchronization signal occupies a lower quantity of OFDM symbols than the first synchronization signal.

In some examples of the method, apparatus, and non-transitory computer-readable medium described herein, the second synchronization signal may be received less frequently than the first synchronization signal.

In some examples of the method, ambient wireless devices, and non-transitory computer-readable medium described herein, decoding the OFDM signal may include operations, features, means, or instructions for discarding a quantity of samples of a set of multiple samples of the OFDM signal associated with the at least one cyclic prefix.

In some examples of the method, ambient wireless devices, and non-transitory computer-readable medium described herein, the OFDM signal includes an on-off keying (OOK) waveform and one or more cyclic prefixes.

A method for wireless communications by an ambient wireless device is described. The method may include receiving one or more synchronization signals indicating a cyclic prefix duration associated with OFDM signaling, receiving, subsequent to the reception of the one or more synchronization signals, an OFDM signal including at least one cyclic prefix, and decoding the OFDM signal based on a discard of the at least one cyclic prefix from the OFDM signal in accordance with the cyclic prefix duration.

An ambient wireless device for wireless communications is described. The ambient wireless device may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the ambient wireless device to receive one or more synchronization signals indicating a cyclic prefix duration associated with OFDM signaling, receive, subsequent to the reception of the one or more synchronization signals, an OFDM signal including at least one cyclic prefix, and decode the OFDM signal based on a discard of the at least one cyclic prefix from the OFDM signal in accordance with the cyclic prefix duration.

Another ambient wireless device for wireless communications is described. The ambient wireless device may include means for receiving one or more synchronization signals indicating a cyclic prefix duration associated with OFDM signaling, means for receiving, subsequent to the reception of the one or more synchronization signals, an OFDM signal including at least one cyclic prefix, and means for decoding the OFDM signal based on a discard of the at least one cyclic prefix from the OFDM signal in accordance with the cyclic prefix duration.

A non-transitory computer-readable medium storing code for wireless communications is described. The code may include instructions executable by one or more processors (e.g., directly, indirectly, after pre-processing, without pre-processing) to receive one or more synchronization signals indicating a cyclic prefix duration associated with OFDM signaling, receive, subsequent to the reception of the one or more synchronization signals, an OFDM signal including at least one cyclic prefix, and decode the OFDM signal based on a discard of the at least one cyclic prefix from the OFDM signal in accordance with the cyclic prefix duration.

Some examples of the method, ambient wireless devices, and non-transitory computer-readable medium described herein may further include operations, features, means, or instructions for receiving an indication of a subcarrier spacing associated with the at least one cyclic prefix, where the at least one cyclic prefix may be discarded based on the subcarrier spacing.

In some examples of the method, ambient wireless devices, and non-transitory computer-readable medium described herein, receiving the one or more synchronization signals may include operations, features, means, or instructions for receiving a single synchronization signal indicating a first cyclic prefix configuration of a set of multiple cyclic prefix configurations may be applied to the OFDM signal, where the at least one cyclic prefix may be discarded based on the first cyclic prefix configuration.

In some examples of the method, ambient wireless devices, and non-transitory computer-readable medium described herein, the one or more synchronization signals indicate a presence of one or more cyclic prefixes in the OFDM signal.

In some examples of the method, ambient wireless devices, and non-transitory computer-readable medium described herein, the one or more synchronization signals indicate a symbol position of one or more cyclic prefixes in the OFDM signal.

In some examples of the method, ambient wireless devices, and non-transitory computer-readable medium described herein, the one or more synchronization signals indicate a symbol boundary associated with one or more symbols of the OFDM signal.

In some examples of the method, ambient wireless devices, and non-transitory computer-readable medium described herein, receiving the one or more synchronization signals may include operations, features, means, or instructions for receiving a first synchronization signal for synchronizing with a symbol boundary and receiving a second synchronization signal indicating a first cyclic prefix configuration of a set of multiple cyclic prefix configurations may be applied to the OFDM signal, where the at least one cyclic prefix may be discarded based on the first cyclic prefix configuration.

In some examples of the method, ambient wireless devices, and non-transitory computer-readable medium described herein, the second synchronization signal may be received after reception of the first synchronization signal.

In some examples of the method, ambient wireless devices, and non-transitory computer-readable medium described herein, the second synchronization signal occupies a lower quantity of OFDM symbols than the first synchronization signal.

In some examples of the method, ambient wireless devices, and non-transitory computer-readable medium described herein, the second synchronization signal may be received less frequently than the first synchronization signal.

In some examples of the method, ambient wireless devices, and non-transitory computer-readable medium described herein, decoding the OFDM signal may include operations, features, means, or instructions for discarding a quantity of samples of a set of multiple samples of the OFDM signal associated with the at least one cyclic prefix.

In some examples of the method, ambient wireless devices, and non-transitory computer-readable medium described herein, the OFDM signal includes an OOK waveform and one or more cyclic prefixes.

A method for wireless communication by an apparatus is described. The method may include receiving one or more synchronization signals indicating a cyclic prefix duration associated with OFDM signaling, receiving, subsequent to the reception of the one or more synchronization signals, an OFDM signal including at least one cyclic prefix, and decoding the OFDM signal based on a discard of the at least one cyclic prefix from the OFDM signal in accordance with the cyclic prefix duration.

An apparatus for wireless communication is described. The apparatus may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the apparatus to receive one or more synchronization signals indicating a cyclic prefix duration associated with OFDM signaling, receive, subsequent to the reception of the one or more synchronization signals, an OFDM signal including at least one cyclic prefix, and decode the OFDM signal based on a discard of the at least one cyclic prefix from the OFDM signal in accordance with the cyclic prefix duration.

Another apparatus for wireless communication is described. The apparatus may include means for receiving one or more synchronization signals indicating a cyclic prefix duration associated with OFDM signaling, means for receiving, subsequent to the reception of the one or more synchronization signals, an OFDM signal including at least one cyclic prefix, and means for decoding the OFDM signal based on a discard of the at least one cyclic prefix from the OFDM signal in accordance with the cyclic prefix duration.

A non-transitory computer-readable medium storing code for wireless communication is described. The code may include instructions executable by one or more processors (e.g., directly, indirectly, after pre-processing, without pre-processing) to receive one or more synchronization signals indicating a cyclic prefix duration associated with OFDM signaling, receive, subsequent to the reception of the one or more synchronization signals, an OFDM signal including at least one cyclic prefix, and decode the OFDM signal based on a discard of the at least one cyclic prefix from the OFDM signal in accordance with the cyclic prefix duration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports forward link waveforms with cyclic prefix signaling for ambient internet of things (AIOT) devices in accordance with one or more aspects of the present disclosure.

FIG. 2 shows an example of a wireless communications system that supports forward link waveforms with cyclic prefix signaling for AIOT devices in accordance with one or more aspects of the present disclosure.

FIG. 3 shows an example of a process flow that supports forward link waveforms with cyclic prefix signaling for AIOT devices in accordance with one or more aspects of the present disclosure.

FIGS. 4 and 5 show block diagrams of devices that support forward link waveforms with cyclic prefix signaling for AIOT devices in accordance with one or more aspects of the present disclosure.

FIG. 6 shows a block diagram of a communications manager that supports forward link waveforms with cyclic prefix signaling for AIOT devices in accordance with one or more aspects of the present disclosure.

FIG. 7 shows a diagram of a system including a device that supports forward link waveforms with cyclic prefix signaling for AIOT devices in accordance with one or more aspects of the present disclosure.

FIG. 8 shows a flowchart illustrating methods that support forward link waveforms with cyclic prefix signaling for AIOT devices in accordance with one or more aspects of the present disclosure.

### DETAILED DESCRIPTION

In some wireless communications systems, wireless devices may implement on-off keying (OOK) waveforms for forward link communications. Such OOK waveforms may be generated using an orthogonal frequency division multiplexing (OFDM) waveform. For example, an ambient internet of things (AIOT) device may detect signaling transmitted via an OOK waveform using envelope detection. In some cases, the OOK waveform may be transmitted to the AIOT device without a cyclic prefix, and the AIOT device may perform envelope detection without processing the cyclic prefix of the OOK waveform. In some other cases, the OOK waveform may be transmitted with a cyclic prefix. However, the AIOT device may be unaware of a location and duration of the cyclic prefix within the OOK waveform, and thus may not be able to remove the cyclic prefix from the OOK waveform.

Various aspects of the present disclosure are related to forward link waveforms with cyclic prefix signaling for AIOT devices. An AIOT device may receive one or more synchronization signals indicating a time duration of a cyclic prefix for OFDM signaling. For example, the AIOT device may receive one synchronization signal indicating a cyclic prefix duration and a starting OFDM symbol of an OFDM signal. Alternatively, or additionally, the AIOT device may receive a first synchronization signal for synchronizing with a transmitter and may receive a second synchronization signal indicating whether the OFDM signal includes a cyclic prefix, a cyclic prefix duration, and a starting OFDM symbol of an OFDM signal. The AIOT device may determine a boundary between OFDM symbols of the OFDM signal based on the one or more synchronization signals. Then, the AIOT device may receive the OFDM signal and may skip (e.g., discard) a region associated with at least one cyclic prefix of the OFDM signal based on the location and cyclic prefix duration indicated by the one or more synchronization signals.

Aspects of the disclosure are initially described in the context of wireless communications systems. Aspects of the disclosure are additionally illustrated with reference to process flows. Aspects of the disclosure are further illustrated by and described with reference to apparatus diagrams, system diagrams, and flowcharts that relate to forward link waveforms with cyclic prefix signaling for AIOT devices.

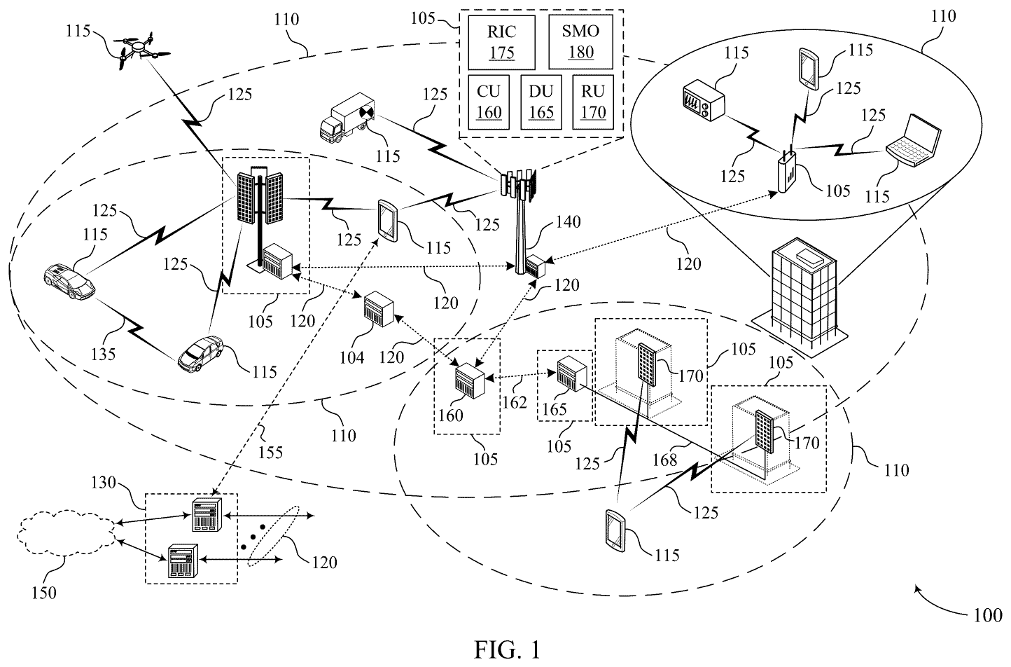

FIG. 1 shows an example of a wireless communications system 100 that supports forward link waveforms with cyclic prefix signaling for AIOT devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, an IoT device (e.g., an AIOT device, a UE 115) may receive one or more synchronization signals associated with OFDM signaling from a wireless device (e.g., a network entity 105). The one or more synchronization signals may indicate information associated with an upcoming OFDM signal transmitted by the wireless device. For example, the AIOT device may receive one synchronization signal indicating a cyclic prefix duration, a starting OFDM symbol of an OFDM signal, and whether the OFDM symbol includes the cyclic prefix. Alternatively, the AIOT device may receive a first synchronization signal indicating the cyclic prefix duration and the starting OFDM symbol for the OFDM signal and may receive a second synchronization signal indicating whether the OFDM signal includes a cyclic prefix. The AIOT device may determine a boundary associated with the OFDM symbols (e.g., an OFDM symbol boundary) based on the one or more synchronization signals. Accordingly, the AIOT device may receive the OFDM signal and may skip (e.g., discard) the cyclic prefix of the OFDM signal based on the cyclic prefix duration, the starting OFDM symbol, and the OFDM symbol boundary.

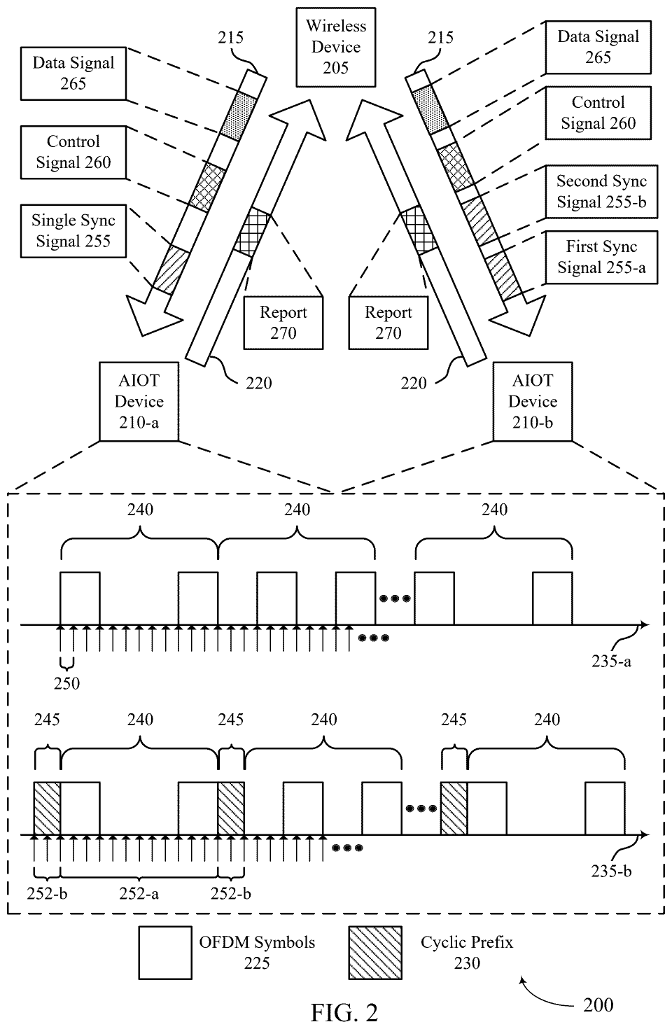

FIG. 2 shows an example of a wireless communications system 200 that supports forward link waveforms with cyclic prefix signaling for AIOT devices in accordance with one or more aspects of the present disclosure. The wireless communications system 200 may include a wireless device 205 in communications with an AIOT device 210, including the AIOT device 210-a and the AIOT device 210-b. In some examples, the wireless device 205 may be an example of a network entity, including a network entity 105 as described herein with reference to FIG. 1. The AIOT devices 210 may be examples of IoT devices as described herein with reference to FIG. 1. For example, the AIOT devices 210 may be low complexity devices that may wirelessly harvest energy from transmissions by other devices and may also, in some cases, communicate by backscattering of transmissions by other devices. In some examples, AIOT devices 210 may also be examples of UEs 115 as described with reference to FIG. 1. The wireless device 205 may communicate with the AIOT devices 210 via one or more communication links, including a forward link 215 (e.g., a downlink) and a reverse link 220 (e.g., an uplink).

In some examples, the AIOT devices 210 may detect signaling received via the forward link 215 by implementing envelope tracking. In such examples, the AIOT devices 210 may be low-tier devices (e.g., low-energy devices). For example, the AIOT devices 210 may not include (e.g., be equipped with) active radio-frequency (RF) components, such as a local oscillator. The AIOT devices 210 may perform the envelope tracking on signaling received from the wireless device 205 without knowing a carrier frequency offset associated with the signaling or without performing frequency synchronization (e.g., with the wireless device 205). By implementing the envelope tracking, AIOT devices 210 may receive downlink signaling without performing down-conversion on the downlink signaling.

In some examples, the wireless device 205 may transmit signaling via the forward link 215 using an OOK waveform. For example, the wireless device 205 may transmit a low-power wakeup signal (LP-WUS) to the AIOT devices 210 via an OOK waveform. The wireless device 205 may generate the OOK waveform using an OFDM waveform. For example, the wireless device 205 may generate a waveform including one or more ODFM symbols 225. Accordingly, the wireless device 205 may multiplex the OOK waveform with other signals transmitted to the AIOT devices 210.

In some examples (e.g., standalone deployment), the wireless device 205 may generate the OOK waveform without including a cyclic prefix 230. In such examples, the AIOT devices 210 may perform envelope detection on the OOK waveform without cyclic prefix processing. That is, the AIOT devices 210 may not implement a fast Fourier transform (FFT) to receive the OOK waveform. In some other examples, (e.g., co-source transmission within a frequency band, within a guard band), the wireless device 205 may generate the OOK waveform with a cyclic prefix 230. Including the cyclic prefix 230 in the OOK waveform may enable the wireless device 205 to multiplex the OOK waveform with other transmissions. The AIOT devices 210 may be capable of processing OOK waveforms with a cyclic prefix 230 and OOK waveforms without a cyclic prefix 230.

In the example of FIG. 2, the AIOT devices 210 may receive an OOK waveform in accordance with the timeline 235-a or 235-b. The timeline 235-a may illustrate an OOK waveform generated without the cyclic prefix 230, and the timeline 235-b may illustrate an OOK waveform generated with the cyclic prefix 230. Each OOK waveform may include multiple ODFM symbols 225. The OFDM symbols 225 may be associated with an OFDM symbol duration 240. The OFDM symbol duration 240 may indicate a period (e.g., a time period) during which the AIOT devices 210 may receive OFDM symbols 225. Similarly, the cyclic prefix 230 may be associated with a cyclic prefix duration 245. The cyclic prefix duration 245 may indicate a period during which the AIOT devices 210 may receive a cyclic prefix 230.

The AIOT devices 210 may sample the OOK waveform in accordance with a sampling frequency 250 to determine sampling points 252 for receiving and decoding the OOK waveform. In some examples, the AIOT devices 210 may determine (e.g., select) the sampling frequency 250 such that the cyclic prefix duration 245 may be divided (e.g., partitioned) into an integer quantity of samples. For example, the AIOT devices 210 may divide the OOK waveform into sampling points 252-a corresponding to the OFDM symbols 225 and sampling points 252-b corresponding to a cyclic prefix 230. In such examples, the AIOT devices may select a low sampling frequency 250 relative to a non-AIOT device.

To process OOK waveforms with a cyclic prefix 230, the AIOT devices 210 may skip a cyclic prefix 230 of an OOK waveform and perform envelope detection on the OOK waveform. The AIOT devices 210 may skip the cyclic prefix 230 based on the cyclic prefix duration 245 (e.g., discard or otherwise not consider the sampling points of the cyclic prefix 230). Additionally, the AIOT devices 210 may skip the cyclic prefix in accordance with an OFDM symbol index. The OFDM symbol index may indicate a beginning of an OFDM symbol 225 that includes a cyclic prefix 230. In some examples, the cyclic prefix may occur at the beginning of the OFDM symbol 225.

In some examples, the wireless device 205 may initiate forward link communications with the AIOT devices 210 by transmitting one or more synchronization signals to the AIOT devices 210 to indicate information associated with the OFDM symbols 225. In some examples, the wireless device 205 may transmit a single sync signal 255 to the AIOT device 210-a. The single sync signal 255 may be multiple bits (e.g., ten or more bits) in length and may occupy one or more multiple OFDM symbols 225. In some examples, the single sync signal 255 may occupy multiple OFDM symbols 225 in accordance with the sampling frequency 250 of the AIOT device 210-a which may be low (e.g., 1.92 MHZ). The length of the single sync signal may be configured to reduce the likelihood that the AIOT device 210-a mis-detects the single sync signal 255 and declares a false alarm.

The AIOT device 210-a may determine the position of a starting OFDM symbol 225, the symbol boundary of the OFDM symbols 225, or both based on processing the single sync signal 255 (e.g., after decoding the single sync signal 255). For example, the position of a starting OFDM symbol 225 within a slot may be fixed within the slot, and the AIOT device 210-a may determine the position of the starting OFDM symbol 225 for the single sync signal 255 and for subsequent signaling (e.g., OFDM signaling) received from the wireless device 205. Additionally, the length of the single sync signal 255 may be selected (e.g., configured by the wireless device 205) such that the single sync signal 255 occupies an integer quantity of OFDM symbols 225. As such, the AIOT device 210-a may know an OFDM symbol position and OFDM symbol boundary after detecting the single sync signal 255.

In some examples, the single sync signal 255 may also indicate a cyclic prefix configuration for the OFDM signaling. For example, the single sync signal 255 may indicate a cyclic prefix configuration from a set of cyclic prefix configurations (e.g., multiple hypothesized configurations) for the OFDM signaling. In some cases, the single sync signal 255 may indicate that the OFDM signaling includes a cyclic prefix 230. If the single sync signal 255 indicates the inclusion of the cyclic prefix 230, the single sync signal 255 may also indicate a location of the cyclic prefix 230 (e.g., a location within an OFDM symbol 225), a cyclic prefix duration 245, or both. The cyclic prefix configuration may also indicate a subcarrier spacing associated with the cyclic prefix 230. For example, the cyclic prefix configuration may indicate a subcarrier spacing of 15 kHz or 30 kHz for the cyclic prefix 230. In some other cases, the single sync signal 255 may indicate that the OFDM signaling does not include the cyclic prefix 230. To reduce signaling between the AIOT device 210-a and the wireless device 205, the AIOT device 210-a may be restricted to operate in accordance with a subcarrier spacing for a fixed cyclic prefix duration 245.

After receiving the single sync signal 255, the AIOT device 210 may determine the symbol boundary of the OFDM symbols 225, the location of the cyclic prefix 230, and the cyclic prefix duration 245. Accordingly, the AIOT device 210-a may identify sampling points 252-b corresponding to the cyclic prefix 230 and may discard the sampling points 252-b. The AIOT device 210-a may perform envelope detection on the sampling points 252-a to receive and decode the OOK waveform and corresponding bit sequence.

In some other examples, the wireless device 205 may communicate multiple synchronization signals to the AIOT devices 210 to simplify processing at the AIOT devices 210. For example, the wireless device 205 may transmit a first sync signal 255-a (e.g., a primary synchronization signal) and a second sync signal 255-b (e.g., a secondary synchronization signal) to the AIOT device 210-b for reducing the complexity of synchronization detection. The AIOT device 210-b may receive the first sync signal 255-a to synchronize with the wireless device 205. For example, the AIOT device 210-b may determine the position of a starting OFDM symbol 225, the symbol boundary of the OFDM symbols 225, or both based on processing the first sync signal 255-a (e.g., after decoding the first sync signal 255-a). As described herein, the position of a starting OFDM symbol 225 within a slot may be fixed within the slot, and the AIOT device 210-b may determine the position of the starting OFDM symbol 225 for the first sync signal 255-a and for subsequent signaling (e.g., OFDM signaling) received from the wireless device 205.

However, unlike the single sync signal 255, the first sync signal 255-a may not indicate information associated with a cyclic prefix 230, such as whether the subsequent signaling includes the cyclic prefix 230. Rather, the second sync signal 255-b may indicate the information associated with the cyclic prefix 230. For example, the second sync signal 255-b may indicate whether the OFDM signaling includes the cyclic prefix 230. If the second sync signal 255-b indicates that the OFDM signaling includes the cyclic prefix 230, the second sync signal 255-b may also indicate a location of the cyclic prefix 230 (e.g., a location within an OFDM symbol 225), a cyclic prefix duration 245, or both. Accordingly, the AIOT device 210-b may determine the location of the cyclic prefix 230 and the cyclic prefix duration 245 based on processing the second sync signal 255-b. Additionally, the second sync signal 255-b may also indicate a cyclic prefix configuration (e.g., of multiple hypothesized configurations) to the AIOT device 210-b.

After receiving both the first sync signal 255-a and the second sync signal 255-b, the AIOT device 210-b may identify and discard the sampling points 252-b corresponding to the cyclic prefix 230. For example, the AIOT device 210-b may determine the position of a starting OFDM symbol 225, the symbol boundary of the OFDM symbols 225, or both, based on processing the first sync signal 255-a and may determine the location of the cyclic prefix 230, and the cyclic prefix duration 245 based on processing the second sync signal 255-b. Accordingly, the AIOT device 210-b may identify and discard the sampling points 252-b corresponding to the cyclic prefix 230. The AIOT device 210-b may perform envelope detection on the sampling points 252-a to receive and decode the OOK waveform and corresponding bit sequence.

In some examples where the wireless device 205 transmits the first sync signal 255-a and the second sync signal 255-b, the first sync signal 255-a and the second sync signal 255-b may simplify processing (e.g., reduce complexity) at the AIOT device 210-b. For example, the first sync signal 255-a may have a shorter length (e.g., occupy fewer OFDM symbols 225) relative to the single sync signal 255 based on the first sync signal not indicating information associated with the cyclic prefix 230. Similarly, because the second sync signal 255-b indicates the information associated with the cyclic prefix 230 and is not used for synchronization with the wireless device 205), the wireless device 205 may configure a length of the second sync signal 255-b to be shorter than the first sync signal 255-a. The length of the second sync signal 255-b may be chosen (e.g., selected, determined) such that the second sync signal 255-b occupies an integer quantity of OFDM symbols 225. In some cases, the second sync signal 255-b may occupy one (e.g., a single) OFDM symbol 225.

The wireless device 205 may transmit the second sync signal 255-b after transmitting the first sync signal 255-a. In some examples, the wireless device 205 may leave a time gap between the first sync signal 255-a and the second sync signal 255-b. That is, the wireless device 205 may delay transmitting the second sync signal 255-b until a time duration after transmitting the first sync signal 255-a. The wireless device 205 may leave the time gap to allow the AIOT device 210-b to decode the first sync signal 255-a. In some cases, the wireless device 205 may transmit the second sync signal 255-b less frequently (e.g., transmitted at a lower periodicity) than the first sync signal 255-a to reduce signaling overhead.

After transmitting the single sync signal 255 or after transmitting the first sync signal 255-a and the second sync signal 255-b, the wireless device 205 may transmit subsequent signaling (e.g., OFDM signaling) to the AIOT devices 210 including a control signal 260, or a data signal 265, or both. In some cases, the wireless device 205 may transmit the control signal 260 to inform the AIOT devices 210 about the data signal 265. That is, the control signal 260 may indicate the data signal 265 to the AIOT devices 210. Each of the control signal 260 and the data signal 265 may comprise an OFDM signal including an OOK waveform and at least one cyclic prefix 230. For example, the control signal 260, the data signal 265, or both may include at least one cyclic prefix 230.

The AIOT devices 210 may decode the control signal 260 and the data signal 265 based on decoding the single sync signal 255 or the first sync signal 255-a and the second sync signal 255-b. For example, the AIOT devices 210 may decode the single sync signal 255 or may decode both the first sync signal 255-a and the second sync signal 255-b to determine the symbol boundary of the OFDM symbols 225, the location of the cyclic prefix 230, and the cyclic prefix duration 245. Accordingly, the AIOT devices 210 may identify and discard sampling points 252-b of the control signal 260 and the data signal 265 corresponding to the cyclic prefix 230. For example, the AIOT devices 210 may skip one or more cyclic prefixes 230 included in the control signal 260 and the data signal 265 in accordance with the symbol boundary of the OFDM symbols 225, the location of the cyclic prefix 230, and the cyclic prefix duration 245. The AIOT devices 210 may perform envelope detection on the sampling points 252-a of the control signal 260 and the data signal 265 to receive and decode the OOK waveform and corresponding bit sequence. The AIOT devices 210 may transmit a report 270 to the wireless device 205 after decoding the control signal 260 and the data signal 265.

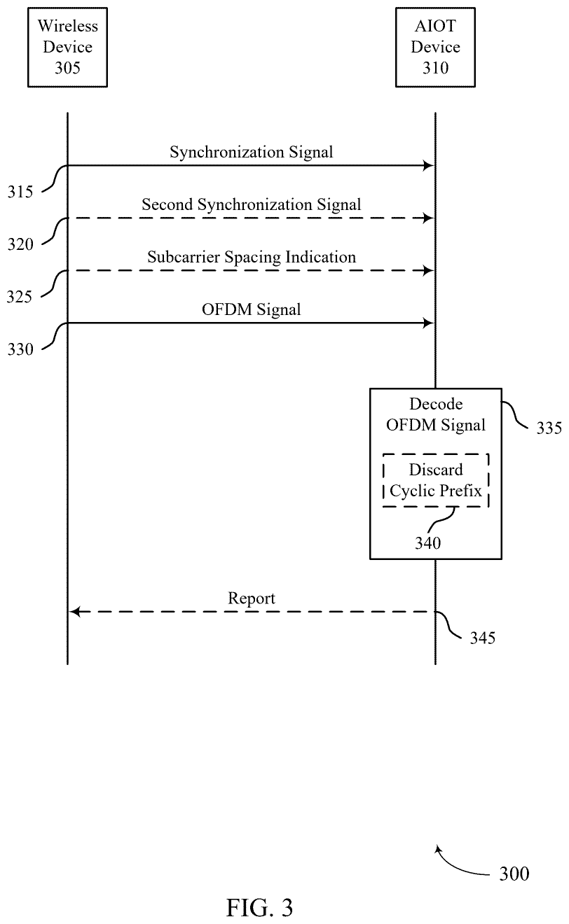

FIG. 3 shows an example of process flow 300 that supports forward link waveforms with cyclic prefix signaling for AIOT devices in accordance with one or more aspects of the present disclosure. The process flow 300 may implement or be implemented by aspects of the wireless communications system 100 and the wireless communications system 200, as described with reference to FIGS. 1 and 2. For example, the process flow 300 illustrates actions performed by a wireless device 305 and an ambient wireless device 310, which may be examples of corresponding devices described herein, including with reference to FIGS. 1-2. For example, the ambient wireless device 310 may be an example of an AIOT device 210 as described with reference to FIG. 2. In the following description of the process flow 300, the operations between the wireless device 305 and the ambient wireless device 310 may be performed in a different order than the example shown, or the operations between the wireless device 305 and the ambient wireless device 310 may be performed in different orders at different times. Some operations may also be omitted from the process flow 300, and other operations may be added to the process flow 300.

The ambient wireless device 310 may receive one or more synchronization signals indicating a cyclic prefix duration associated with OFDM signaling (e.g., an OFDM signal). The one or more synchronization signals may indicate a presence of one or more cyclic prefixes in the OFDM signal, a symbol position of one or more cyclic prefixes in the OFDM signal, a duration of the one or more cyclic prefixes (e.g., a cyclic prefix duration), a symbol boundary associated with one or more symbols of the OFDM signal, or any combination thereof. The symbol position of the one or more cyclic prefixes may indicate one or more OFDM symbols that include a cyclic prefix, may indicate a location of the one or more cyclic prefixes within the one or more OFDM symbols, or both.

In some examples, the OFDM signal may include an OOK waveform and one or more cyclic prefixes. For example, the wireless device 305 may generate the OFDM signal to include the OOK waveform and the one or more cyclic prefixes. The ambient wireless device 310 may identify one or more sampling points corresponding to the one or more cyclic prefixes based on the presence of one or more cyclic prefixes in the OFDM signal, the symbol position of one or more cyclic prefixes in the OFDM signal, the duration of the one or more cyclic prefixes (e.g., a cyclic prefix duration), the symbol boundary associated with one or more symbols of the OFDM signal, or any combination thereof. The ambient wireless device 310 may discard the identified sampling points to obtain (e.g., determine) a bit sequence corresponding to the OOK waveform.

In some examples, at 315, the ambient wireless device 310 may receive a single synchronization signal indicating that a first cyclic prefix configuration of a plurality of cyclic prefix configurations is applied to the OFDM signal. Each of the plurality of cyclic prefix configurations may be associated with a cyclic prefix length and a subcarrier spacing. The single synchronization signal may indicate the presence of the one or more cyclic prefixes in the OFDM signal, the symbol position of one or more cyclic prefixes in the OFDM signal, a subcarrier spacing associated with the one or more cyclic prefixes in the OFDM signal, the symbol boundary associated with one or more symbols of the OFDM signal, or any combination thereof. The ambient wireless device 310 may identify the sampling points corresponding to the one or more cyclic prefixes based on the subcarrier spacing.

In some other examples, at 315, the ambient wireless device 310 may receive one of multiple synchronization signals from the wireless device 305. For example, the ambient wireless device 310 may receive a first synchronization signal for synchronizing with a symbol boundary (e.g., the symbol boundary associated with one or more symbols of the OFDM signal). The first synchronization signal may indicate the symbol position of the one or more cyclic prefixes in the OFDM signal, the symbol boundary associated with one or more symbols of the OFDM signal, or both.

If the ambient wireless device 310 receives the first synchronization signal, at 320, the ambient wireless device 310 may receive a second synchronization signal indicating that the first cyclic prefix configuration of the plurality of cyclic prefix configurations is applied to the OFDM signal. For example, the second synchronization signal may indicate the presence of the one or more cyclic prefixes in the OFDM signal, a duration of the one or more cyclic prefixes in the OFDM signal, or both. In some examples, the second synchronization signal may occupy a lower quantity of OFDM symbols than the first synchronization signal. The second synchronization signal may be received after reception of the first synchronization signal. In some cases, the second synchronization signal may be received less frequently (e.g., less often, at a lower periodicity) than the first synchronization signal.

At 325, the ambient wireless device 310 may receive an indication of a subcarrier spacing associated with at least one cyclic prefix (e.g., the at least one cyclic prefix included in the OFDM signaling). In some examples where the ambient wireless device 310 receives the single synchronization signal at 315, the ambient wireless device 310 may also receive the indication via the single synchronization signal. In some other examples where the ambient wireless device 310 receives the first synchronization signal at 315, the ambient wireless device 310 may receive the indication via the second synchronization signal. Alternatively, or additionally, the ambient wireless device 310 may receive additional signaling that includes the indication of the subcarrier spacing. The ambient wireless device 310 may identify the sampling points corresponding to the one or more cyclic prefixes based on the subcarrier spacing.

At 330, the ambient wireless device 310 may receive, subsequent to the reception of the one or more synchronization signals, the OFDM signal including the at least one cyclic prefix. In some examples, the OFDM signal may include a control signal, a data signal, or both. The control signal, the data signal, or both, may include the at least one cyclic prefix. In some cases, the control signal may be transmitted prior to the data signal, where each of the control signal and the data signal may include a cyclic prefix as indicated by the one or more synchronization signals.

At 335, the ambient wireless device 310 may decode the OFDM signal based on a discard of the at least one cyclic prefix from the OFDM signal in accordance with the cyclic prefix duration. In some examples, to decode the OFDM signal, the ambient wireless device 310 may skip (e.g., discard) the at least one cyclic prefix. For example, at 340, the ambient wireless device 310 may discard a quantity of samples of a plurality of samples of the OFDM signal associated with the at least one cyclic prefix. The ambient wireless device 310 may discard the quantity of samples based on the indication of the presence of the one or more cyclic prefixes in the OFDM signal, the symbol position of one or more cyclic prefixes in the OFDM signal, the symbol boundary associated with one or more symbols of the OFDM signal, or any combination thereof. Additionally, the at least one cyclic prefix may be discarded based on the first cyclic prefix configuration, the subcarrier spacing, or both.

In some examples, the ambient wireless device 310 may determine the plurality of samples in accordance with a sampling frequency, which the ambient wireless device 310 may determine based on the at least one cyclic prefix. For example, the ambient wireless device 310 may determine the sampling frequency such that the at least one cyclic prefix may be divided into an integer quantity of samples.

At 345, the ambient wireless device 310 may transmit signaling to the wireless device 305. For example, the ambient wireless device 310 may transmit a report to the wireless device 305 responsive to decoding the OFDM signal.

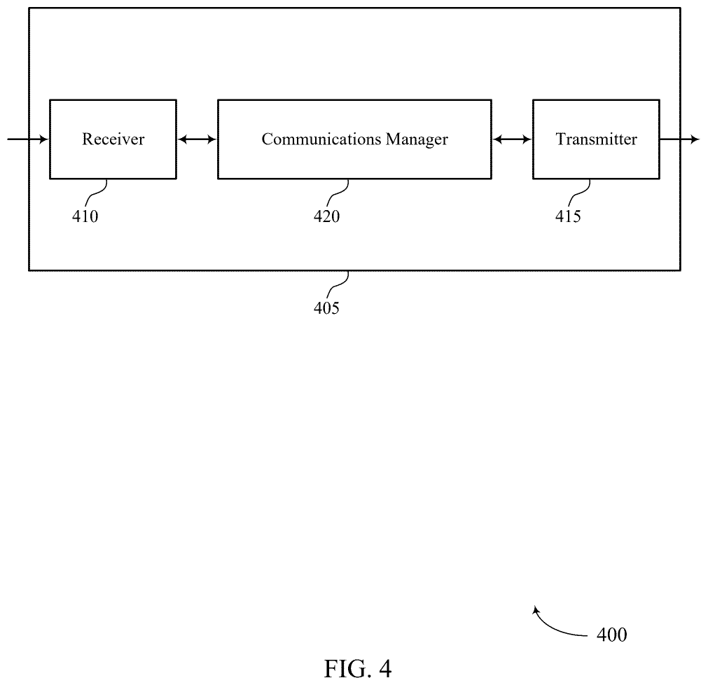

FIG. 4 shows a block diagram 400 of a device 405 that supports forward link waveforms with cyclic prefix signaling for AIOT devices in accordance with one or more aspects of the present disclosure. The device 405 may be an example of aspects of an ambient wireless device as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to forward link waveforms with cyclic prefix signaling for AIOT devices). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to forward link waveforms with cyclic prefix signaling for AIOT devices). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of forward link waveforms with cyclic prefix signaling for AIOT devices as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), a graphics processing unit (GPU) a neural processing unit (NPU), an application-specific integrated circuit (ASIC), a field-programmable gate array (FPGA), or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for one or more memories storing processor-executable code. The communications manager 420 is capable of, configured to, or operable to support a means for one or more processors coupling with the one or more memories and individually or collectively operable to cause the ambient wireless device to. The communications manager 420 is capable of, configured to, or operable to support a means for receiving one or more synchronization signals indicating a cyclic prefix duration associated with OFDM signaling. The communications manager 420 is capable of, configured to, or operable to support a means for receiving, subsequent to the reception of the one or more synchronization signals, an OFDM signal including at least one cyclic prefix. The communications manager 420 is capable of, configured to, or operable to support a means for decoding the OFDM signal based on a discard of the at least one cyclic prefix from the OFDM signal in accordance with the cyclic prefix duration.

Additionally, or alternatively, the communications manager 420 may support wireless communications in accordance with examples as disclosed herein. For example, the communications manager 420 is capable of, configured to, or operable to support a means for receiving one or more synchronization signals indicating a cyclic prefix duration associated with OFDM signaling. The communications manager 420 is capable of, configured to, or operable to support a means for receiving, subsequent to the reception of the one or more synchronization signals, an OFDM signal including at least one cyclic prefix. The communications manager 420 is capable of, configured to, or operable to support a means for decoding the OFDM signal based on a discard of the at least one cyclic prefix from the OFDM signal in accordance with the cyclic prefix duration.

Additionally, or alternatively, the communications manager 420 may support wireless communication in accordance with examples as disclosed herein. For example, the communications manager 420 is capable of, configured to, or operable to support a means for receiving one or more synchronization signals indicating a cyclic prefix duration associated with OFDM signaling. The communications manager 420 is capable of, configured to, or operable to support a means for receiving, subsequent to the reception of the one or more synchronization signals, an OFDM signal including at least one cyclic prefix. The communications manager 420 is capable of, configured to, or operable to support a means for decoding the OFDM signal based on a discard of the at least one cyclic prefix from the OFDM signal in accordance with the cyclic prefix duration.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing.

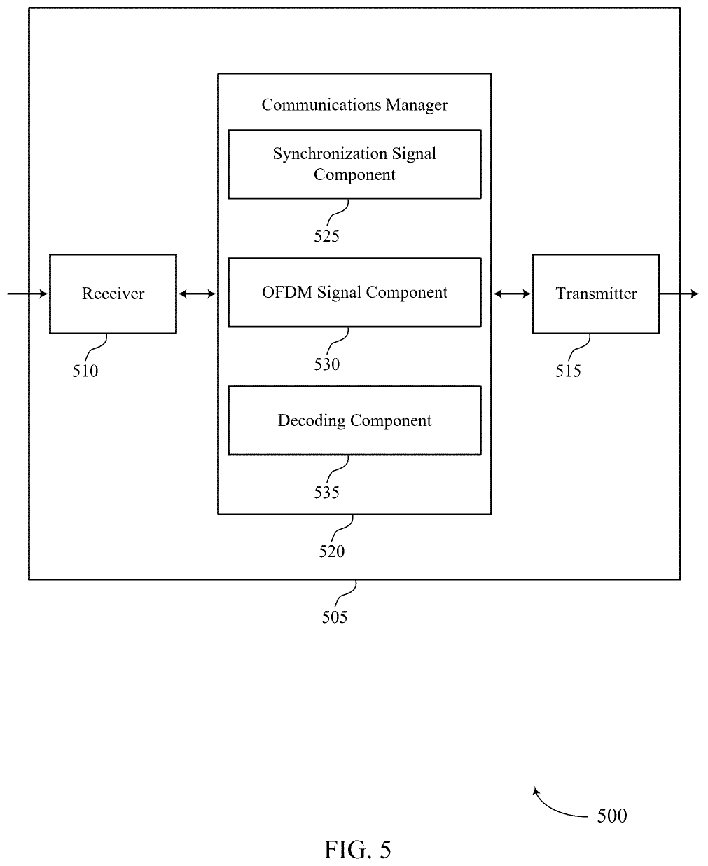

FIG. 5 shows a block diagram 500 of a device 505 that supports forward link waveforms with cyclic prefix signaling for AIOT devices in accordance with one or more aspects of the present disclosure. The device 505 may be an example of aspects of a device 405 or an ambient wireless device (e.g., an AIOT device, a UE 115) as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to forward link waveforms with cyclic prefix signaling for AIOT devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to forward link waveforms with cyclic prefix signaling for AIOT devices). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of forward link waveforms with cyclic prefix signaling for AIOT devices as described herein. For example, the communications manager 520 may include a synchronization signal component 525, an OFDM signal component 530, a decoding component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The synchronization signal component 525 is capable of, configured to, or operable to support a means for receiving one or more synchronization signals indicating a cyclic prefix duration associated with OFDM signaling. The OFDM signal component 530 is capable of, configured to, or operable to support a means for receiving, subsequent to the reception of the one or more synchronization signals, an OFDM signal including at least one cyclic prefix. The decoding component 535 is capable of, configured to, or operable to support a means for decoding the OFDM signal based on a discard of the at least one cyclic prefix from the OFDM signal in accordance with the cyclic prefix duration.

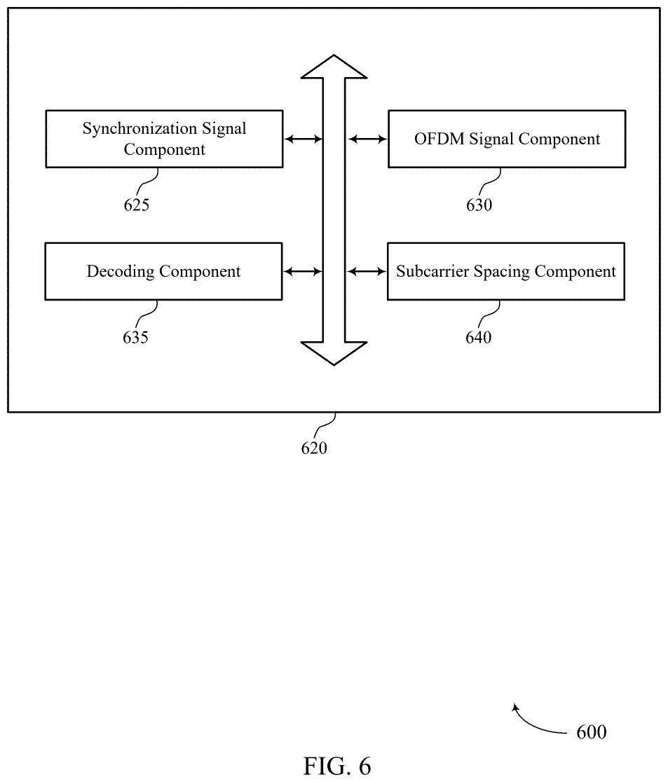

FIG. 6 shows a block diagram 600 of a communications manager 620 that supports forward link waveforms with cyclic prefix signaling for AIOT devices in accordance with one or more aspects of the present disclosure. The communications manager 620 may be an example of aspects of a communications manager 420, a communications manager 520, or both, as described herein. The communications manager 620, or various components thereof, may be an example of means for performing various aspects of forward link waveforms with cyclic prefix signaling for AIOT devices as described herein. For example, the communications manager 620 may include a synchronization signal component 625, an OFDM signal component 630, a decoding component 635, a subcarrier spacing component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The synchronization signal component 625 is capable of, configured to, or operable to support a means for receiving one or more synchronization signals indicating a cyclic prefix duration associated with OFDM signaling. In some examples, the OFDM signal component 630 is capable of, configured to, or operable to support a means for receiving, subsequent to the reception of the one or more synchronization signals, an OFDM signal including at least one cyclic prefix. In some examples, the decoding component 635 is capable of, configured to, or operable to support a means for decoding the OFDM signal based on a discard of the at least one cyclic prefix from the OFDM signal in accordance with the cyclic prefix duration.

In some examples, the subcarrier spacing component 640 is capable of, configured to, or operable to support a means for receiving an indication of a subcarrier spacing associated with the at least one cyclic prefix, where the at least one cyclic prefix is discarded based on the subcarrier spacing.

In some examples, to support receiving one or more synchronization signals, the synchronization signal component 625 is capable of, configured to, or operable to support a means for receiving a single synchronization signal indicating a first cyclic prefix configuration of a set of multiple cyclic prefix configurations is applied to the OFDM signal, where the at least one cyclic prefix is discarded based on the first cyclic prefix configuration.

In some examples, the one or more synchronization signals indicate a presence of one or more cyclic prefixes in the OFDM signal.

In some examples, the one or more synchronization signals indicate a symbol position of one or more cyclic prefixes in the OFDM signal.

In some examples, the one or more synchronization signals indicate a symbol boundary associated with one or more symbols of the OFDM signal.

In some examples, to support receiving the one or more synchronization signals, the synchronization signal component 625 is capable of, configured to, or operable to support a means for receiving a first synchronization signal for synchronizing with a symbol boundary. In some examples, to support receiving the one or more synchronization signals, the synchronization signal component 625 is capable of, configured to, or operable to support a means for receiving a second synchronization signal indicating a first cyclic prefix configuration of a set of multiple cyclic prefix configurations is applied to the OFDM signal, where the at least one cyclic prefix is discarded based on the first cyclic prefix configuration.

In some examples, the second synchronization signal is received after reception of the first synchronization signal.

In some examples, the second synchronization signal occupies a lower quantity of OFDM symbols than the first synchronization signal.

In some examples, the second synchronization signal is received less frequently than the first synchronization signal.

In some examples, to support decoding the OFDM signal, the decoding component 635 is capable of, configured to, or operable to support a means for discarding a quantity of samples of a set of multiple samples of the OFDM signal associated with the at least one cyclic prefix.

In some examples, the OFDM signal includes an OOK waveform and one or more cyclic prefixes.

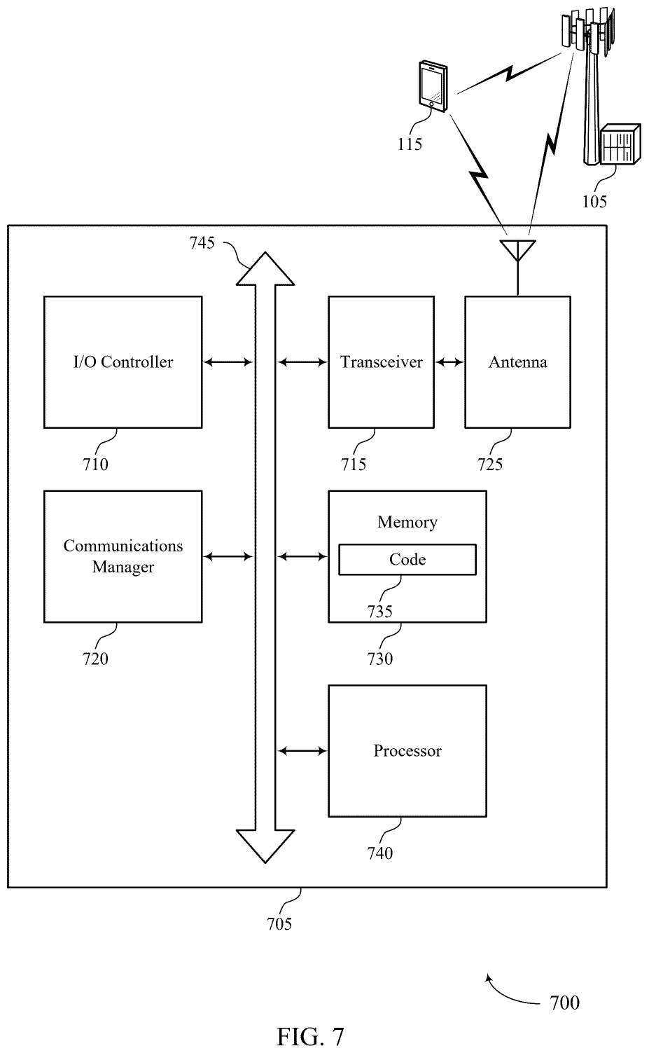

FIG. 7 shows a diagram of a system 700 including a device 705 that supports forward link waveforms with cyclic prefix signaling for AIOT devices in accordance with one or more aspects of the present disclosure. The device 705 may be an example of or include components of a device 405, a device 505, or an ambient wireless device as described herein. The device 705 may include components for bi-directional voice and data communications including components for transmitting and receiving communications, such as a communications manager 720, an I/O controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include RAM and ROM. The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a BIOS which may control basic hardware or software operation such as the interaction with peripheral components or devices.

The at least one processor 740 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting forward link waveforms with cyclic prefix signaling for AIOT devices). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for one or more memories storing processor-executable code. The communications manager 720 is capable of, configured to, or operable to support a means for one or more processors coupling with the one or more memories and individually or collectively operable to cause the ambient wireless device to. The communications manager 720 is capable of, configured to, or operable to support a means for receiving one or more synchronization signals indicating a cyclic prefix duration associated with OFDM signaling. The communications manager 720 is capable of, configured to, or operable to support a means for receiving, subsequent to the reception of the one or more synchronization signals, an OFDM signal including at least one cyclic prefix. The communications manager 720 is capable of, configured to, or operable to support a means for decoding the OFDM signal based on a discard of the at least one cyclic prefix from the OFDM signal in accordance with the cyclic prefix duration.

Additionally, or alternatively, the communications manager 720 may support wireless communications in accordance with examples as disclosed herein. For example, the communications manager 720 is capable of, configured to, or operable to support a means for receiving one or more synchronization signals indicating a cyclic prefix duration associated with OFDM signaling. The communications manager 720 is capable of, configured to, or operable to support a means for receiving, subsequent to the reception of the one or more synchronization signals, an OFDM signal including at least one cyclic prefix. The communications manager 720 is capable of, configured to, or operable to support a means for decoding the OFDM signal based on a discard of the at least one cyclic prefix from the OFDM signal in accordance with the cyclic prefix duration.

Additionally, or alternatively, the communications manager 720 may support wireless communication in accordance with examples as disclosed herein. For example, the communications manager 720 is capable of, configured to, or operable to support a means for receiving one or more synchronization signals indicating a cyclic prefix duration associated with OFDM signaling. The communications manager 720 is capable of, configured to, or operable to support a means for receiving, subsequent to the reception of the one or more synchronization signals, an OFDM signal including at least one cyclic prefix. The communications manager 720 is capable of, configured to, or operable to support a means for decoding the OFDM signal based on a discard of the at least one cyclic prefix from the OFDM signal in accordance with the cyclic prefix duration.

By including or configuring the communications manager 720 in accordance with examples as described herein, the device 705 may support techniques for improved communication reliability and improved user experience related to reduced processing.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of forward link waveforms with cyclic prefix signaling for AIOT devices as described herein, or the at least one processor 740 and the at least one memory 730 may be otherwise configured to, individually or collectively, perform or support such operations.

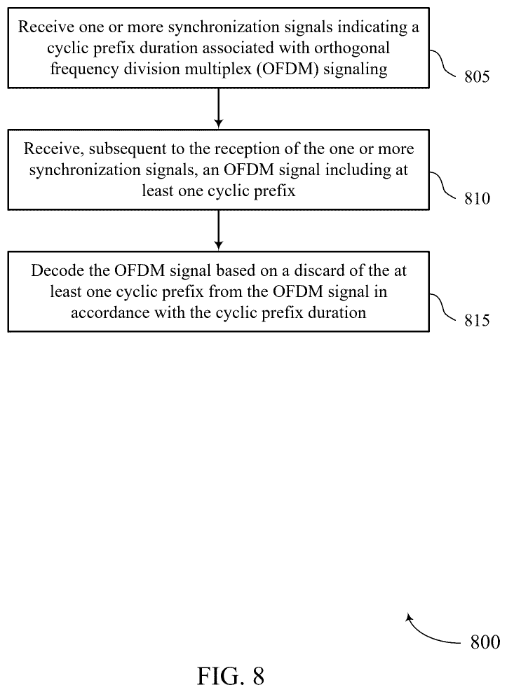

FIG. 8 shows a flowchart illustrating a method 800 that supports forward link waveforms with cyclic prefix signaling for AIOT devices in accordance with one or more aspects of the present disclosure. The operations of the method 800 may be implemented by an ambient wireless device or its components as described herein. For example, the operations of the method 800 may be performed by an ambient wireless device as described with reference to FIGS. 1 through 7. In some examples, an ambient wireless device may execute a set of instructions to control the functional elements of the ambient wireless device to perform the described functions. Additionally, or alternatively, the ambient wireless device may perform aspects of the described functions using special-purpose hardware.

At 805, the method may include receiving one or more synchronization signals indicating a cyclic prefix duration associated with OFDM signaling. The operations of 805 may be performed in accordance with examples as disclosed herein. In some examples, aspects of the operations of 805 may be performed by a synchronization signal component 625 as described with reference to FIG. 6.

At 810, the method may include receiving, subsequent to the reception of the one or more synchronization signals, an OFDM signal including at least one cyclic prefix. The operations of 810 may be performed in accordance with examples as disclosed herein. In some examples, aspects of the operations of 810 may be performed by an OFDM signal component 630 as described with reference to FIG. 6.

At 815, the method may include decoding the OFDM signal based on a discard of the at least one cyclic prefix from the OFDM signal in accordance with the cyclic prefix duration. The operations of 815 may be performed in accordance with examples as disclosed herein. In some examples, aspects of the operations of 815 may be performed by a decoding component 635 as described with reference to FIG. 6.

The following provides an overview of aspects of the present disclosure:

Aspect 1: A method for wireless communications at an ambient wireless device, comprising: receiving one or more synchronization signals indicating a cyclic prefix duration associated with OFDM signaling, receiving, subsequent to the reception of the one or more synchronization signals, an OFDM signal comprising at least one cyclic prefix; and decoding the OFDM signal based at least in part on a discard of the at least one cyclic prefix from the OFDM signal in accordance with the cyclic prefix duration.

Aspect 2: The method of aspect 1, further comprising: receiving an indication of a subcarrier spacing associated with the at least one cyclic prefix, wherein the at least one cyclic prefix is discarded based at least in part on the subcarrier spacing.

Aspect 3: The method of any of aspects 1 through 2, wherein receiving the one or more synchronization signals further comprises: receiving a single synchronization signal indicating a first cyclic prefix configuration of a plurality of cyclic prefix configurations is applied to the OFDM signal, wherein the at least one cyclic prefix is discarded based at least in part on the first cyclic prefix configuration.

Aspect 4: The method of any of aspects 1 through 3, wherein the one or more synchronization signals indicate a presence of one or more cyclic prefixes in the OFDM signal.

Aspect 5: The method of any of aspects 1 through 4, wherein the one or more synchronization signals indicate a symbol position of one or more cyclic prefixes in the OFDM signal.

Aspect 6: The method of any of aspects 1 through 5, wherein the one or more synchronization signals indicate a symbol boundary associated with one or more symbols of the OFDM signal.

Aspect 7: The method of any of aspects 1 through 2, wherein receiving the one or more synchronization signals further comprises: receiving a first synchronization signal for synchronizing with a symbol boundary; and receiving a second synchronization signal indicating a first cyclic prefix configuration of a plurality of cyclic prefix configurations is applied to the OFDM signal, wherein the at least one cyclic prefix is discarded based at least in part on the first cyclic prefix configuration.

Aspect 8: The method of aspect 7, wherein the second synchronization signal is received after reception of the first synchronization signal.

Aspect 9: The method of any of aspects 7 through 8, wherein the second synchronization signal occupies a lower quantity of OFDM symbols than the first synchronization signal.

Aspect 10: The method of any of aspects 7 through 9, wherein the second synchronization signal is received less frequently than the first synchronization signal.

Aspect 11: The method of any of aspects 1 through 10, wherein decoding the OFDM signal further comprises: discarding a quantity of samples of a plurality of samples of the OFDM signal associated with the at least one cyclic prefix.

Aspect 12: The method of any of aspects 1 through 11, wherein the OFDM signal comprises an OOK waveform and one or more cyclic prefixes.

Aspect 13: An ambient wireless device for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the ambient wireless device to perform a method of any of aspects 1 through 12.

Aspect 14: An ambient wireless device for wireless communications, comprising at least one means for performing a method of any of aspects 1 through 12.

Aspect 15: A non-transitory computer-readable medium storing code for wireless communications, the code comprising instructions executable by one or more processors (e.g., directly, indirectly, after pre-processing, without pre-processing) to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An ambient wireless device for wireless communications, comprising:
one or more memories storing processor-executable code; and
one or more processors coupled with the one or more memories and individually or collectively operable to cause the ambient wireless device to:
receive one or more synchronization signals indicating a cyclic prefix duration associated with orthogonal frequency division multiplex (OFDM) signaling;
receive, subsequent to the reception of the one or more synchronization signals, an OFDM signal comprising at least one cyclic prefix; and
decode the OFDM signal based at least in part on a discard of the at least one cyclic prefix from the OFDM signal in accordance with the cyclic prefix duration.

2. The ambient wireless device of claim 1, wherein the one or more processors are individually or collectively operable to execute the code to cause the ambient wireless device to:
receive an indication of a subcarrier spacing associated with the at least one cyclic prefix, wherein the at least one cyclic prefix is discarded based at least in part on the subcarrier spacing.

3. The ambient wireless device of claim 1, wherein, to receive one or more synchronization signals, the one or more processors are individually or collectively operable to execute the code to cause the ambient wireless device to:
receive a single synchronization signal indicating a first cyclic prefix configuration of a plurality of cyclic prefix configurations is applied to the OFDM signal, wherein the at least one cyclic prefix is discarded based at least in part on the first cyclic prefix configuration.

4. The ambient wireless device of claim 1, wherein the one or more synchronization signals indicate a presence of one or more cyclic prefixes in the OFDM signal.

5. The ambient wireless device of claim 1, wherein the one or more synchronization signals indicate a symbol position of one or more cyclic prefixes in the OFDM signal.

6. The ambient wireless device of claim 1, wherein the one or more synchronization signals indicate a symbol boundary associated with one or more symbols of the OFDM signal.

7. The ambient wireless device of claim 1, wherein, to receive the one or more synchronization signals, the one or more processors are individually or collectively operable to execute the code to cause the ambient wireless device to:
receive a first synchronization signal for synchronizing with a symbol boundary; and
receive a second synchronization signal indicating a first cyclic prefix configuration of a plurality of cyclic prefix configurations is applied to the OFDM signal, wherein the at least one cyclic prefix is discarded based at least in part on the first cyclic prefix configuration.

8. The ambient wireless device of claim 7, wherein the second synchronization signal is received after reception of the first synchronization signal.

9. The ambient wireless device of claim 7, wherein the second synchronization signal occupies a lower quantity of OFDM symbols than the first synchronization signal.

10. The ambient wireless device of claim 7, wherein the second synchronization signal is received less frequently than the first synchronization signal.

11. The ambient wireless device of claim 1, wherein, to decode the OFDM signal, the one or more processors are individually or collectively operable to execute the code to cause the ambient wireless device to:
discard a quantity of samples of a plurality of samples of the OFDM signal associated with the at least one cyclic prefix.

12. The ambient wireless device of claim 1, wherein the OFDM signal comprises an on-off keying waveform and one or more cyclic prefixes.

13. A method for wireless communications at an ambient wireless device, comprising:
receiving one or more synchronization signals indicating a cyclic prefix duration associated with orthogonal frequency division multiplex (OFDM) signaling,
receiving, subsequent to the reception of the one or more synchronization signals, an OFDM signal comprising at least one cyclic prefix; and
decoding the OFDM signal based at least in part on a discard of the at least one cyclic prefix from the OFDM signal in accordance with the cyclic prefix duration.

14. The method of claim 13, further comprising:
receiving an indication of a subcarrier spacing associated with the at least one cyclic prefix, wherein the at least one cyclic prefix is discarded based at least in part on the subcarrier spacing.

15. The method of claim 13, wherein receiving the one or more synchronization signals further comprises:
receiving a single synchronization signal indicating a first cyclic prefix configuration of a plurality of cyclic prefix configurations is applied to the OFDM signal, wherein the at least one cyclic prefix is discarded based at least in part on the first cyclic prefix configuration.

16. The method of claim 13, wherein the one or more synchronization signals indicate a presence of one or more cyclic prefixes in the OFDM signal.

17. The method of claim 13, wherein the one or more synchronization signals indicate a symbol position of one or more cyclic prefixes in the OFDM signal.

18. The method of claim 13, wherein the one or more synchronization signals indicate a symbol boundary associated with one or more symbols of the OFDM signal.

19. The method of claim 13, wherein receiving the one or more synchronization signals further comprises:
receiving a first synchronization signal for synchronizing with a symbol boundary; and
receiving a second synchronization signal indicating a first cyclic prefix configuration of a plurality of cyclic prefix configurations is applied to the OFDM signal, wherein the at least one cyclic prefix is discarded based at least in part on the first cyclic prefix configuration.

20. A non-transitory computer-readable medium storing code for wireless communication, the code comprising instructions executable by one or more processors to:
receive one or more synchronization signals indicating a cyclic prefix duration associated with orthogonal frequency division multiplex (OFDM) signaling,
receive, subsequent to the reception of the one or more synchronization signals, an OFDM signal comprising at least one cyclic prefix; and
decode the OFDM signal based at least in part on a discard of the at least one cyclic prefix from the OFDM signal in accordance with the cyclic prefix duration.
